(19) United States
(12) Patent Application Publication
(10) Pub. No.: US 2009/0162175 A1
(43) Pub. Date: Jun. 25, 2009

(54) VEHICLE ENTRY APPARATUS

(76) Inventor: Simon J. PEARSON, Birmingham (GB)

Correspondence Address: NIXON & VANDERHYE, PC, 901 NORTH GLEBE ROAD, 11TH FLOOR, ARLINGTON, VA, 22203, US

(21) Appl. No.: 12/247,625

(22) Filed: Oct. 8, 2008

(30) Foreign Application Priority Data
Dec. 21, 2007 (GB) GB0724957.6

(51) Int. Cl. E01D 1/00; B60P 1/00

(52) U.S. Cl. 414/545; 14/71.1

(57) ABSTRACT

A vehicle entry apparatus for a vehicle having a door opening and a sill, the apparatus comprising a platform and rotatable mounting means for mounting the platform adjacent the door opening, the platform having a surface for supporting a wheelchair thereon, wherein the platform is rotatable, in use, between a stowed position, in which the surface is positioned or positionable below at least part of the sill, and a loading position, in which the platform extends or is extendable through the door opening, and various embodiments.

The present invention relates generally to a vehicle entry apparatus. More specifically, although not exclusively, the present invention relates to a vehicle entry apparatus for facilitating the loading of a wheelchair into a vehicle.

Apparatus for this purpose are known which consist of a lifting apparatus, wherein the wheelchair is loaded onto a platform which is subsequently raised to the height of the vehicle floor and the wheelchair is manoeuvred into place. These apparatus require high powered lifting means to lift the individual and wheelchair to the requisite height and a significant amount of space for manoeuvring of the wheelchair into a forward facing position for travel.

Further solutions have also been proposed which include a retractable or removable ramp to facilitate the loading of a wheelchair into a vehicle through a rear or sliding side passenger door.

GB2009097 proposes an apparatus having a tiltable and swivellable platform mounted to the vehicle. The platform includes an extension which is slideable relative thereto, wherein the platform and extension together form a ramp. The wheelchair is driven or manoeuvred backward up the ramp until it reaches a point of balance, at which point the platform tilts to its horizontal position. The extension is then retracted and the platform is rotated to a travel position. This apparatus is said to require a specialised kind of wheelchair having adjustment for the height of the seat in relation to the wheels.

It is a non-exclusive object of the invention to provide an apparatus which overcomes or at least mitigates the issues of the prior art.

According to a first aspect of the invention, there is provided a vehicle entry apparatus for a vehicle having a door opening and a sill, the apparatus comprising a platform and rotatable mounting means for mounting the platform adjacent the door opening, the platform having a surface for supporting a wheelchair thereon, wherein the platform is rotatable, in use, between a stowed position, in which the surface is positioned or positionable below at least part of the sill, and a loading position, in which the platform extends or is extendable through the door opening.

According to a specific embodiment of the first aspect of the invention, there is provided a vehicle comprising a sill, a door opening and a platform rotatably mounted adjacent the door opening and having a surface for supporting a wheelchair thereon, wherein the platform is rotatable, in use, between a stowed position, in which the surface is positioned or positionable below at least part of the sill, and a loading position, in which it extends or is extendable through the door opening.

The relatively low surface of the platform allows the vehicle to accommodate most standard wheelchairs. The use of a rotatable platform permits loading of the wheelchair into a forward facing position without the need for manoeuvring it after loading.

According to a second aspect of the invention, there is provided a vehicle entry apparatus comprising a platform having rotatable mounting means for mounting the platform to a vehicle adjacent a door thereof and a ramp connected or connectable to the platform, wherein the platform is rotatable, in use, about an axis of rotation which corresponds substantially to a hinge of the door such that the platform may be orientated to correspond substantially to the orientation of the door in an open condition.

The vehicle or apparatus may comprise a ramp, for example which is connected or connectable to the platform. The connection may be such that the ramp slopes downwardly, in use, at an angle with respect to the platform, for example when the apparatus is in the loading position.

According to a third aspect of the invention, there is provided a vehicle entry apparatus comprising a platform and a ramp connected or connectable to the platform, the platform having rotatable mounting means for mounting the platform to a vehicle adjacent a door thereof, wherein the apparatus is operable, in use, between a stowed position in which the platform is in a first orientation and a loading position in which the platform is rotated with respect to the first orientation and the ramp slopes or is able to slope downwardly at an angle with respect to the platform.

Providing a ramp connected or connectable to, and at an angle with respect to, a rotatable platform provides a simple and robust construction.

The ramp may be pivotable with respect to the platform, for example pivotably mounted thereto. In one embodiment, the ramp is slideably mounted to the platform, for example such that it is telescopically slideable with respect thereto. The ramp may be movable, for example slideable, between a stowed position and a fully extended position, wherein the ramp may be free to slope, for example pivotable, with respect to the platform in the fully extended position. The apparatus may comprise a pair of ramps which may be interconnected by a cross piece.

Additionally or alternatively, the ramp may be removably connected to the platform.

The platform may be mounted or mountable to the floor of the vehicle, for example within a recess in the floor. The platform is preferably shaped to prevent, in use, interference between its edges and one or more surfaces of the recess, for example the platform may be square or rectangular in shape with chamfered corners.

The mounting means may be adjacent a front end of the platform, for example offset from the centre thereof. The mounting means may comprise a bearing means, for example a slew ring or mating means, such as a tongue and groove arrangement. The mounting means is preferably mounted on, secured to or extends from a bottom surface of the platform. The tongue and groove arrangement may comprise a protrusion on the bottom surface of the platform, for example with one or more tongue portions protruding from a side wall thereof, which cooperates with a curved recess in the floor or floor recess of a vehicle, for example which curved recess has a groove in a side wall thereof. The recess may be in the platform and/or the protrusion may be in the floor.

Additionally or alternatively, the mounting means may comprise connection means for connecting, in use, the platform to the door, for example such that the platform is movable with the door. The connection means may comprise a sliding connection, for example to allow for the offset between the axes of rotation of the platform and of the door.

Further aspects of the invention provide a vehicle comprising the vehicle entry apparatus described above, a door and a frame.

The door may be a driver door or a passenger door. The platform may be connected to the door by the connection means, for example for movement therewith. The door may comprise a part sill and/or a pillar of the frame and may comprise one or more locking means for locking or securing the door or the sill, part sill or pillar relative to the frame. The locking means may comprise a retractable pin which engages a hole.

According to a further aspect of the invention, there is provided a vehicle comprising a frame having a sill or pillar, at least part of which sill or pillar is removable, and locking means for locking or securing the at least part of the sill or pillar relative to the rest of the frame, wherein the locking means comprises a retractable pin which engages a hole.

The frame may comprise the retractable pin and the hole may be located in the sill, part sill or pillar, for example in a portion thereof which faces the frame. Additionally or alternatively, the sill or pillar may comprise the or a further retractable pin and the or a further hole may be located in the frame, for example in a portion thereof which faces the sill, part sill or pillar.

The pin may be movable by moving means, such as a hydraulically actuated and/or mechanically actuated and/or electrically actuated moving means.

The vehicle may further comprise a sliding door, wherein the sliding door preferably overlaps or engages the sill, for example to provide the or a further locking means for securing the door relative to the frame.

Embodiments of the invention will now be described, by way of example only, with reference to the accompanying drawings in which:

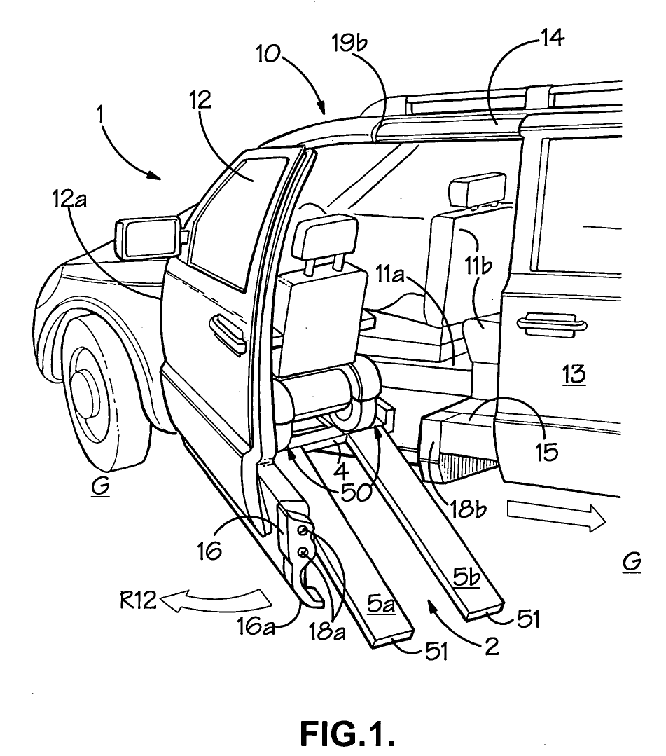

FIG. 1 is a partial perspective view of a first embodiment of vehicle with an entry apparatus according to the invention fitted therein;

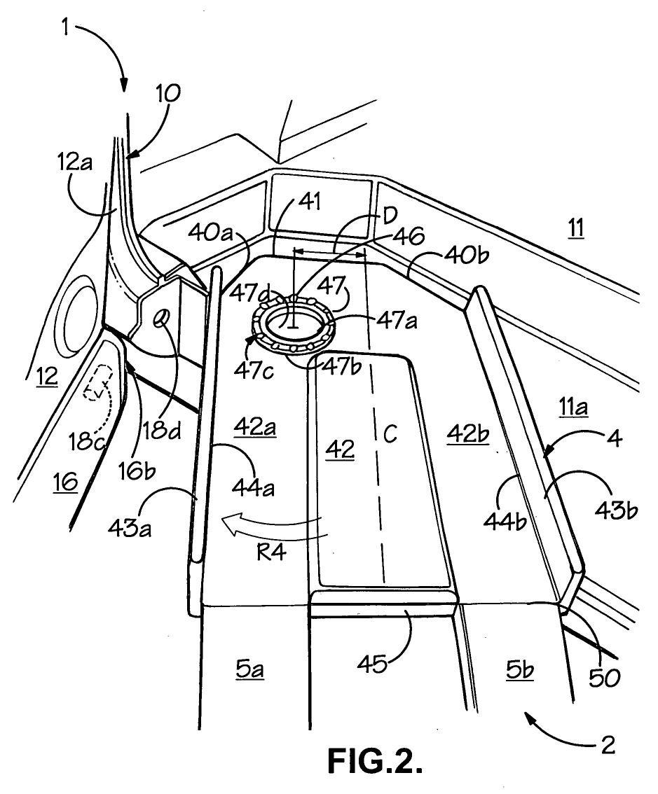

FIG. 2 is a partial perspective view of the vehicle entry apparatus of FIG. 1 illustrating the hidden rotatable mounting means;

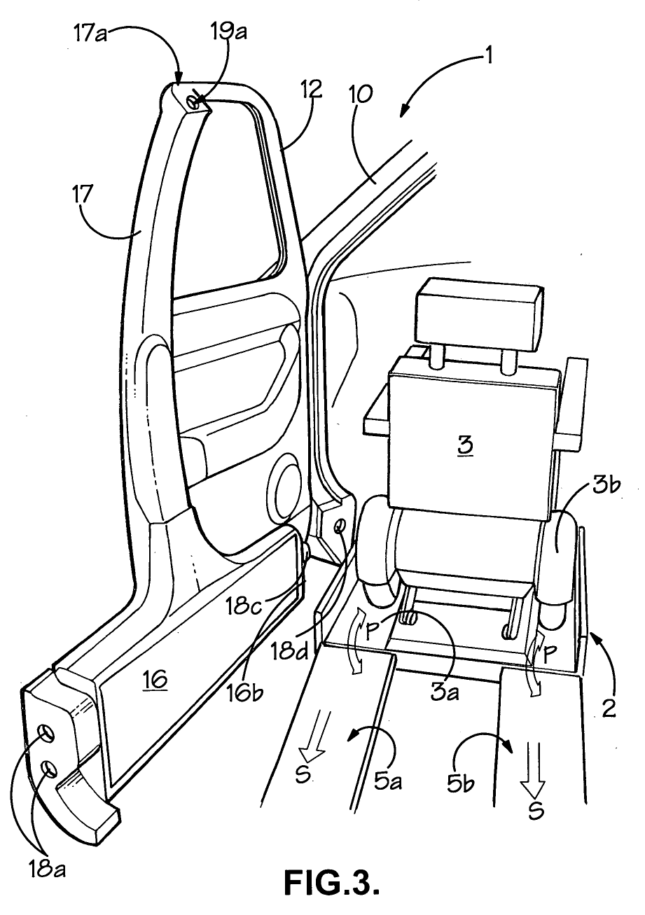

FIG. 3 is a further partial perspective view similar view to FIG. 1 showing the locking means;

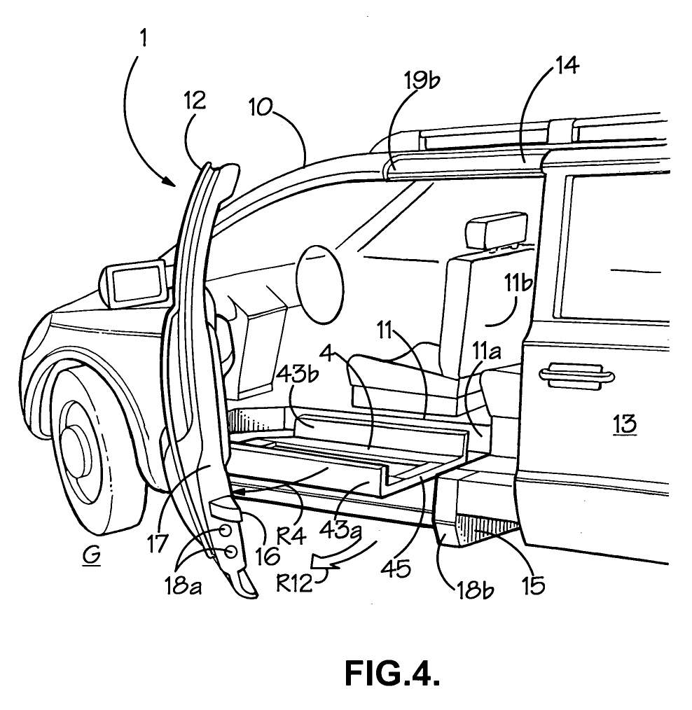

FIG. 4 is a partial perspective view of the vehicle entry apparatus of FIG. 1 in a stowed condition;

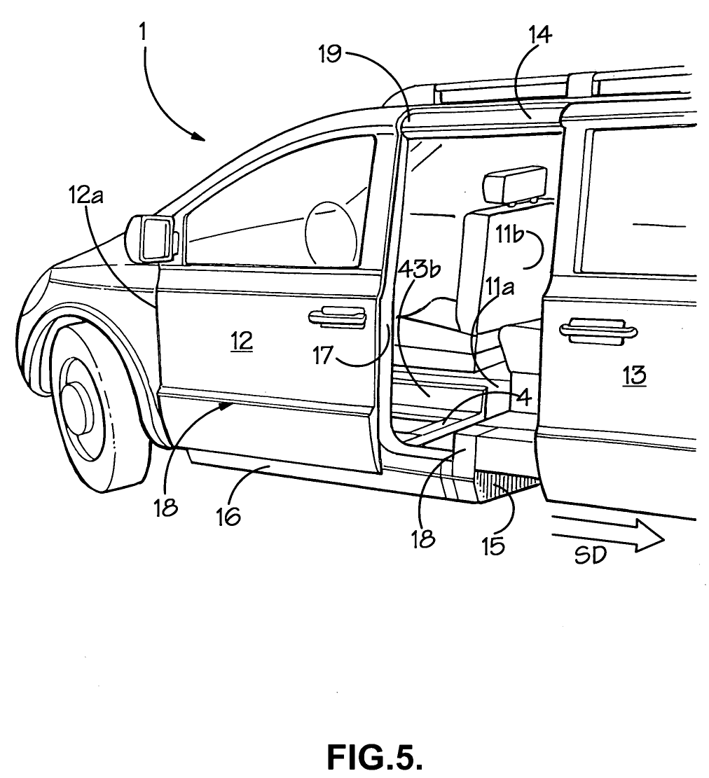

FIG. 5 is a partial perspective view of the vehicle with the front door in a shut position; and

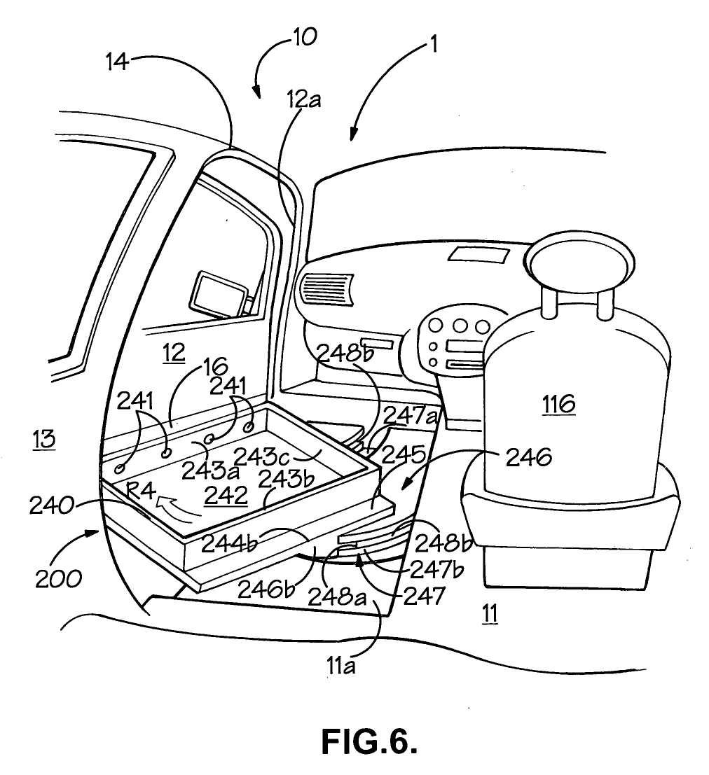

FIG. 6 is a partial perspective view of a second embodiment of vehicle with an entry apparatus according to the invention fitted therein.

Referring to FIGS. 1 to 3, there is shown a vehicle 1 resting on a substrate G, which vehicle 1 has a vehicle entry apparatus 2 according to the invention fitted therein for facilitating the loading of a wheelchair 3 into the vehicle 1. The vehicle 1 includes a frame 10, a floor 11 having a recess 11a therein, a front door 12 which is pivotable about a hinge 12a, a sliding door 13 and seats 11b mounted to the floor 11. The vehicle entry apparatus 2 includes a platform 4 and a pair of ramps 5a, 5b.

The platform 4 is substantially rectangular in plan with chamfered corners 40a, 40b at a front end 41 thereof, a raised area 42 along its longitudinal centreline C and a pair of upstanding walls 43a, 43b along its longitudinal edges 44a, 44b. The raised area 42 extends from the rear end 45 of the platform 4 toward the front end 41 to partially define, on either side thereof, a pair of wheel channels 42a, 42b.

The platform 4 also includes rotatable mounting means 46 in the form of a slew ring 47 in this embodiment. The slew ring 47 includes an inner ring 47a, an outer ring 47b and a plurality of bearing balls 47c. The outer ring 47b is secured to the underside of the platform 4 adjacent the front end 41 and is offset from the centreline C by a distance D, which is approximately one quarter of the width of the platform 4 in this embodiment. The inner ring 47a is mounted in the recess 11a of the floor 11 of the vehicle 1 adjacent the hinge 12a of the front door 12. The recess 11a matches substantially the shape of the platform 4, but with additional clearance to allow rotation thereof. Thus, the axis 47d about which the platform 4 rotates is adjacent and substantially parallel to the hinge 12a of the front door 12 such that the platform 4 may be orientated to correspond substantially to the orientation of the front door 12. It will be appreciated that the platform 4 remains substantially horizontal at all times in this embodiment.

Each ramp 5a, 5b is elongate and rectangular in shape with a pair of stops members (not shown) at a first end 50 thereof. The ramps 5a, 5b are slideably received within guides (not shown) on the underside of the platform 4, thereby to provide a telescoping arrangement. The stop members (not shown) engage surfaces of the guides (not shown) to limit the sliding movement S of the ramps 5a, 5b, thereby preventing their complete removal. When the ramps 5a, 5b are in their fully extended position, the cooperation between the stop members (not shown) and the guides (not shown) permits pivoting movement P of the ramps 5a, 5b relative to the platform 4. The other end 51 of each of the ramps 5a, 5b rests on the substrate G when they are in their fully extended and downwardly sloping position.

The frame 10 of the vehicle 1 includes an upper fixed sill 14 and a lower fixed part sill 15. The front door 12 includes a moving part sill 16 forming its lowermost edge and a pillar 17 forming its rearmost edge which projects upwardly from the moving part sill 16. The rearmost end 16a of the moving part sill 16, which extends beyond the pillar 17 as shown in FIG. 3, includes a pair of holes 18a. The holes 18a cooperate with a pair of hydraulically actuated pin mechanisms, shown generally as reference numeral 18b, in a facing portion of the lower fixed part sill 15. The front end 16b of the moving part sill 16 includes a hydraulically actuated pin mechanism, shown generally as reference numeral 18c, which cooperates with a hole 18d in a facing portion of the frame 10. The uppermost end 17a of the pillar 17 includes a hole 19a which cooperates with a hydraulically actuated pin mechanism, shown generally as reference numeral 19b, in the upper fixed sill 14 of the frame 10.

In this embodiment, the sill holes 18a, 18d and cooperating pin mechanisms 18b, 18c provide the sill locking means 18, whilst the pillar hole 19a and cooperating pin mechanism 19b provides the pillar locking means 19. FIG. 5 shows the sill locking means 18 and pillar locking means 19 in a locked condition.

The vehicle entry apparatus 2 is operable between a loading position, shown in FIGS. 1 to 3, and stowed position, shown in FIGS. 4 and 5. In the loading condition, the platform 4 is substantially horizontal and extends rearwardly away from the vehicle 1 and the ramps 5a, 5b slope downwardly at an angle with respect to the platform 4 such that their free ends 51 rest on the substrate G. In the stowed position, the platform 4 extends along the length of the vehicle 1 and the ramps 5a, 5b are in a retracted condition, wherein they are contained within the guides (not shown) of the platform 4.

In order to load the wheelchair 3 into the vehicle 1, the sliding door 13 is first slid back in direction SD. The sill locking means 18 and the pillar locking means 19 are disengaged and the front door 12 is then opened by rotating it in direction R₁₂ about the door hinge 12a until it is in a fully open condition. The platform 4 is then rotated in direction R₄ until it is orientated to correspond substantially to the orientation of the front door 12. The ramps 5a, 5b are then slid out in direction S from their stowed position until they are in their fully extended condition, at which point they are pivoted P downwardly until their free ends 51 contact the substrate G.

The wheelchair 3 is then advanced up the ramps 5a, 5b onto the platform 4 such that the wheels 3a, 3b of the wheelchair 3 rest in the wheel channels 42a, 42b. The ramps 5a, 5b are then pivoted P upwardly until they are substantially horizontal and urged along the guides (not shown) into their stowed position. The platform 4 is then rotated in the opposite direction to direction R₄ until it is orientated in its stowed position, i.e. extending along the length of the vehicle 1.

The front door 12 is then shut and the sill pin mechanisms 18b, 18c engage the sill holes 18a, 18d and the pillar pin mechanism 19b engages the pillar hole 19a to lock the front door 12 in place. The sliding door 13 is then shut such that it overlaps the rearmost end 16a of the moving part sill 16 of the front door 12.

A second embodiment of the invention is shown in FIG. 6, wherein the slew ring 47 is replaced with a tongue and groove arrangement 247 and the platform 240 is fixed to the door 12. This apparatus 200 is similar to the apparatus 2 of FIGS. 1 to 5, wherein like references represent like components and consequently these will not be described herein.

The platform 240 is substantially rectangular in plan with one upstanding wall 243a along a first longitudinal edge (not shown) thereof, a second upstanding wall 243b offset inwardly from the other longitudinal edge 244b thereof and a third upstanding wall 243c along its front edge (not shown). The walls 243a, 243b, 243c divide the platform 240 into a wheelchair receiving portion 242 and an extending portion 245. The first upstanding wall 243a is secured to the part sill 16, and consequently to the door 12, by bolts 241 such that the platform 240 moves together with the door 12.

The platform 240 also includes rotatable mounting means 246 in the form of a tongue and groove arrangement 247. The tongue and groove arrangement 247 includes two protrusions 246b on the underside of the platform 240, each of which cooperates with a respective curved engagement recess 247a, 247b formed in the floor recess 11a. Each protrusion 246b includes a tongue 248a on either side thereof which extends substantially parallel to the platform. Each tongue 248a is received within a respective groove 248b in the facing portion of the relevant engagement recess 247b.

As a result of the tongue and groove arrangement 247, sliding movement between the platform 240 and the floor recess 11a is permitted but vertical movement is prevented. The shape of the curved engagement recesses 247a, 247b ensures that any such sliding movement follows a predetermined curved path corresponding to a rotating motion of the platform 240 along an imaginary axis (not shown). The shape of the curved engagement recesses 247a, 247b in this embodiment cause the platform 240 to rotate about an axis (not shown) along the door hinge 12a. This precludes the need for a sliding connection between the platform 240 and the door 12, which might otherwise be necessary if there was an offset between the axis (not shown) and door hinge 12a.

Several variations to the embodiment described herein are envisaged without departing from the scope of the invention. For example, the ramps 5a, 5b may be replaced with a single ramp and/or may be interconnected by a cross-member to increase the rigidity thereof. The ramp or ramps 5a, 5b may be removable, for example removably connectable to the platform 4, 240 by connection means such as hooks or the like. The connection means may be arranged secure the ramp or ramps 5a, 5b at a pre-determined angle with respect to the platform 4, 240 or to allow pivoting movement therebetween. Additionally or alternatively, the ramp or ramps 5a, 5b may be arranged for only pivoting movement, for example wherein they are substantially upright in their stowed position.

Furthermore, the slew ring 47 or the tongue and groove arrangement 247 may be replaced with any type of bearing means, or any suitable rotatable mounting means. For example, the underside of the platform 4, 240 may be provided with engaging means similar to the second embodiment of the invention but without the tongues and grooves.

The mounting means may be arranged, in some embodiments, to allow the platform 4, 240 to tilt such that it may slope together with the ramp or ramps 5a, 5b in use.

The platform 4, 240 need not be rectangular in shape, for example it may be square and may have chamfered corners or it may be round or elliptical. The platform 4, 240 may include moving means, for example an electric or hydraulic motor which controllably rotates the platform 4, 240 between its loading and stowed positions. The platform 4 may be connected, for example slideably connected, to the front door 12, for example for movement therewith. The front door 12 may include opening means, for example an electric or hydraulic motor which controllably opens and/or closes the door in use.

The apparatus may be configured to be mounted to driver side or the passenger side of the vehicle.

1.-21. (canceled)

22. A vehicle entry apparatus for a vehicle having a door opening and a sill, the apparatus comprising a platform and rotatable mounting means for mounting the platform adjacent the door opening, the platform having a surface for supporting a wheelchair thereon, wherein the platform is rotatable, in use, between a stowed position, in which the surface is positioned or positionable below at least part of the sill, and a loading position, in which the platform extends or is extendable through the door opening.

23. An apparatus as claimed in claim 22, wherein the platform is rotatable, in use, about an axis of rotation which corresponds substantially to, or is parallel and adjacent to, a hinge of the door such that the platform may be orientated to correspond substantially to the orientation of the door in an open condition.

24. An apparatus as claimed in claim 22, further comprising a ramp connected or connectable to the platform.

25. An apparatus as claimed in claim 24, wherein the ramp slopes downwardly, in use, at an angle with respect to the platform when the apparatus is in the loading position.

26. An apparatus as claimed in claim 24, wherein the ramp is pivotable with respect to the platform.

27. An apparatus as claimed in claim 24, wherein the ramp is telescopically slideable with to the platform.

28. An apparatus as claimed in claim 27, wherein the ramp is slideable between a stowed position and a fully extended position, wherein the ramp is free to pivot with respect to the platform in the fully extended position.

29. An apparatus as claimed in claims 24, comprising a pair of ramps.

30. An apparatus as claimed in claim 22, wherein the mounting means comprises a slew ring.

31. An apparatus as claimed in claim 22, wherein the mounting means comprises a tongue and groove arrangement.

32. An apparatus as claimed in claim 31, wherein the tongue and groove arrangement comprises a protrusion on the bottom surface of the platform with one or more tongue portions protruding from a side wall thereof, wherein the or each tongue cooperates with a groove in a curved recess in a floor or floor recess of a vehicle.

33. An apparatus as claimed in claim 22, wherein the mounting means comprises connection means for connecting, in use, the platform to a door such that the platform is movable with the door.

34. A vehicle comprising a frame, a door, a floor and an entry apparatus rotatably mounted to the floor adjacent the door, the apparatus comprising a platform having a surface for supporting a wheelchair thereon, wherein the platform is rotatable, in use, between a stowed position, in which the surface is positioned or positionable below at least part of a sill, and a loading position, in which the platform extends or is extendable through the door opening.

35. A vehicle as claimed in claim 34, wherein the platform is mounted within a recess in the floor, the platform being shaped to prevent, in use, interference between its edges and one or more surfaces of the recess.

36. A vehicle as claimed in claim 34, wherein the door comprises a sill and/or a part sill and/or pillar of the frame and one or more locking means for locking or securing the door or the sill, part sill or pillar relative to the frame.

37. A vehicle as claimed in claim 36, wherein the locking means comprises a retractable pin which engages a hole.

38. A vehicle as claimed in claim 37, wherein the frame comprises the retractable pin and the hole is located in a portion of the sill, part sill or pillar which faces the frame.

39. A vehicle as claimed in claim 37, wherein the sill, part sill or pillar comprises the or a further retractable pin and the or a further hole is located in a portion of the frame which faces the sill, part sill or pillar.

40. A vehicle as claimed in claim 36, further comprising a sliding door, wherein the sliding door overlaps or engages the sill, part sill or pillar to provide the or a further locking means for securing the door relative to the frame.
